(19) United States
(12) Patent Application Publication
(10) Pub. No.: US 2015/0322822 A1
(43) Pub. Date: Nov. 12, 2015

(54) SIMPLIFIED WATER INJECTION SYSTEM FOR COMBINED CYCLE POWER PLANT

(71) Applicant: General Electric Company, Schenectady, NY (US)

(72) Inventors: Hatim Khandwavla, Bangalore (IN); Frank Douglas Beadie, Greer, SC (US); Rajarshi Saha, Bangalore (IN); Indrajit Mazumder, Bangalore (IN); Durgarasad J, Bangalore (IN)

(73) Assignee: General Electric Company, Schenectady, NY (US)

(21) Appl. No.: 14/275,188

(22) Filed: May 12, 2014

(51) Int. Cl. F01K 23/10; F01K 11/02; F01K 7/16; F02C 3/045; F02C 6/18

(52) U.S. Cl. CPC F01K 23/108; F02C 3/045; F02C 6/18; F01K 7/16; F01K 11/02

(57) ABSTRACT

In one or more of the inventive aspects, a boiler feedwater pump may provide feedwater to a heat recovery steam generator, and the heated feedwater may be used for liquid fuel heating in a liquid fuel heater. The feedwater from the boiler feedwater pump may also be used for water injection in a combustor.

One or more aspects of the present invention relate to water injection and liquid fuel heating for a power plant. In particular, one or more aspects of the present invention relate to using boiler feedwater for liquid fuel heating and water injection during liquid fuel operation.

### BACKGROUND OF THE INVENTION

A gas turbine may be incorporated in a combined cycle power plant. As the name suggests, a typical combined cycle power plant combines two or more thermal cycles within a single power plant. There are normally two cycles in a combined cycle power plant classified as “topping” and “bottoming” cycles. Most or all heat is supplied in the topping cycle. The waste heat produced in the topping cycle is utilized in the bottoming cycle, which operates at a lower temperature level than the topping cycle.

In a typical combined cycle power plant, gas turbines are the prime movers to generate power. These gas turbine engines typically have high exhaust flows and relatively high exhaust temperatures. Steam is produced by directing the exhaust gases to a heat recovery steam generator. The produced steam is directed to a steam turbine to produce additional power. In this manner, a gas turbine produces work via the Brayton Cycle, and the steam turbine produces work via the Rankine Cycle.

FIG. 1 illustrates a conventional power plant 100 which is a combined cycle power plant. The power plant 100 includes a gas turbine portion comprising a compressor 110, a combustor 120, and a turbine 130. The power plant 100 also includes a crude oil heater 140, a performance heater 150, a water injection pump 160, a heat recovery steam generator 170, an intermediate pressure boiler feedwater pump 180, and a valve 190.

It is assumed that the combustor 120 is capable of both gas fuel and liquid fuel operation. For the gas fuel operation, gas fuel can be heated before combustion to increase thermal efficiency. In the conventional power plant 100, hot water extracted from an exit of an intermediate pressure economizer 172 (i.e., the water entering an intermediate pressure evaporator) of the heat recovery steam generator 170 is used for heating the gas fuel in the performance heater 150.

Liquid fuel can also be heated prior to combustion to increase efficiency during the liquid fuel operation (e.g., during startup, part load). In FIG. 1, the crude oil heater 140 is used for this purpose.

Additionally, water may be injected during the liquid fuel operation to reduce emissions (NOx, CO). In FIG. 1, the water injection pump 160 is used to inject water into the combustor 120 during the liquid fuel operation. It is seen that liquid fuel heating and water injection are beneficial.

### BRIEF SUMMARY OF THE INVENTION

A non-limiting aspect of the present invention relates to a liquid fuel heating and water injection system of a power plant. The system may include a boiler feedwater pump, a heat recovery steam generator, a liquid fuel heater, and a water injector. The boiler feedwater pump may be configured to provide feedwater at its output. The heat recovery steam generator may be configured to heat water received at its input and to output some or all heated water at its output. The liquid fuel heater may be configured to receive hot water at its input, heat liquid fuel prior to the liquid fuel being combusted in a combustor, and output the used hot water at its output. The water injector may be configured to receive water at its input and inject the received water into the combustor. The output of the boiler feedwater pump may fluidly communicate with the input of the heat recovery steam generator and with the input of the water injector. The output of the heat recovery steam generator fluidly may communicate with the input of the liquid fuel heater and with the input of the water injector. The output of the liquid fuel heater may fluidly communicate with the input of the water injector.

Another non-limiting aspect of the present invention relates to a power plant. The power plant may include a compressor, a combustor, and a gas turbine. The combustor may be configured to combust a fuel-air mixture to drive the gas turbine, in which the fuel-air includes a mixture of compressed air from the compressor and fuel. The fuel being gaseous and/or liquid. The power plant may also include a boiler feedwater pump, a heat recovery steam generator, a liquid fuel heater, a water injector, and a controller. The controller may be configured to control one or more operations of the power plant. The boiler feedwater pump may be configured to provide feedwater at its output. The heat recovery steam generator, whose input may fluidly communicate with the output of the boiler feedwater pump, may be configured to heat the feedwater received at its input and output at least some of the heated feedwater its output. The liquid fuel heater, whose input may fluidly communicates with the output of the heat recovery steam generator, may be configured to heat the liquid fuel prior to the liquid fuel being combusted in the combustor using the received heated feedwater at its input and output the used heated feedwater at its output. The water injector, whose input may fluidly communicates with the output of the BFP 280 and with the output of the heat recovery steam generator, may be configured to receive the feedwater at its input and inject the received feedwater into the combustor.

Yet another non-limiting aspect of the present invention relates to a method of operating a power plant which comprises a boiler feedwater pump, a heat recovery steam generator downstream of the BFP in a fluid path, a liquid fuel heater downstream of the heat recovery steam generator in the fluid path, and a water injector downstream of the LF heater in the fluid path. The method may include providing feedwater to the fluid path towards the heat recovery steam generator and the liquid fuel heater using the boiler feedwater pump. The method may also include determining whether liquid fuel supplied to a combustor should or should not be heated. When it is determined that the liquid fuel should be heated, the method may proceed to heating the liquid fuel. The step of heating the liquid fuel may include directing the feedwater from the boiler feedwater pump to the heat recovery steam generator, heating the directed feedwater in the heat recovery steam generator, providing the heated feedwater to the liquid fuel heater, and heating the liquid fuel in the liquid fuel heater using the heated feedwater from the heat recovery steam generator. The method may further include determining whether water injection into the combustor should or should not take place. When it is determined that the water injection should take place, the method may proceed to injecting the feedwater into the combustor. The step of injecting the feedwater may include directing the feedwater from the boiler feedwater pump to the water injector, and injecting the feedwater into the combustor using the water injector.

The invention will now be described in greater detail in connection with the drawings identified below.

### BRIEF DESCRIPTION OF THE DRAWINGS

These and other features of the present invention will be better understood through the following detailed description of example embodiments in conjunction with the accompanying drawings, in which:

FIG. 1 illustrates a conventional combined cycle power plant;

FIG. 2 illustrates a power plant according to an embodiment of the present invention;

FIG. 3 illustrates a water injector according to an embodiment of the present invention;

FIG. 4 illustrates a water injector according to another embodiment of the present invention;

FIG. 5 is a schematic of a heated feedwater injection mode of the power plant according to an embodiment of the present invention;

FIG. 6 is a schematic of an unheated feedwater injection mode of the power plant according to an embodiment of the present invention;

FIG. 7 is a schematic of a combined heated and unheated unheated feedwater injection mode of the power plant according to an embodiment of the present invention;

FIG. 8 is a flow chart of an example method to operate a power plant according to an embodiment of the present invention;

FIG. 9 is a flow chart of an example process to heat liquid fuel in a power plant according to an embodiment of the present invention; and

FIG. 10 is a flow chart of an example process to inject water in a power plant according to an embodiment of the present invention.

### DETAILED DESCRIPTION OF THE INVENTION

One or more aspects of a novel power plant are described. Among many advantages, the inventive aspects include simplified water injection and liquid fuel heating system which can reduce costs and foot print sizes. Also, the combined cycle efficiency may be increased through the inventive aspects.

In one or more aspects, an arrangement is provided in which boiler feedwater, e.g., from a bottoming cycle, can be used for both liquid fuel (LF) heating as well as for water injection during the LF operation in a power plant. For example, a tapping downstream of a feedwater pump maybe used for the liquid fuel heating. The same feedwater may be sent to a water injection skid that sends the water to the combustor nozzles. The water injection skid may also regulate the flow of the water.

The LF operation of the power plant may be viewed as when liquid fuel is combusted in the combustor of the gas turbine (GT) system. Also, gas fuel (GF) operation of the power plant may be viewed as when gaseous fuel is combusted in the combustor. Note that it is possible that both LF and GF may be combusted at the same time. That is, the GT system of the CCPC may be in both LF and GF operations.

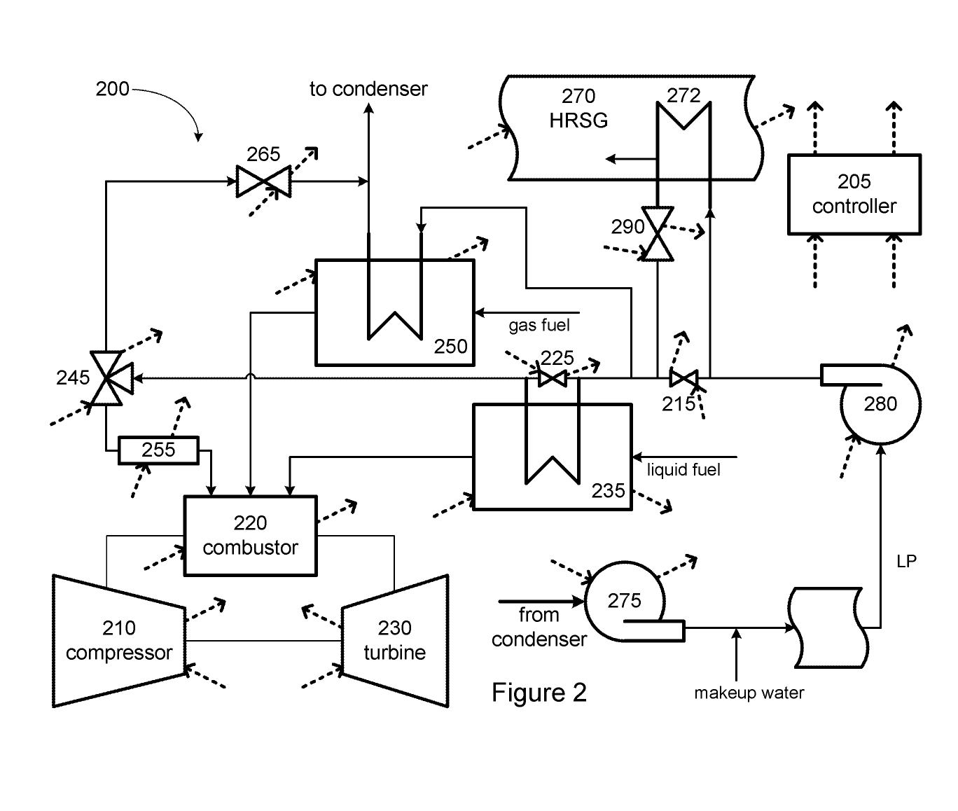

FIG. 2 illustrates an example power plant according to an embodiment of the present invention. In this figure, the power plant 200 is illustrated to be a combined cycle power plant. However, this should not be taken as a requirement. The example power plant 200 may include a controller 205 configured to control the overall functioning of the power plant 200. That is, the controller 205 may be configured to control one or more operations of the power plant 200 including the LF operation and/or the GF operation. The controller 205 may control the operations of the power plant 200 by controlling the one or more of the individual components of the power plant 200.

In FIG. 2, dashed lines entering the controller 205 represent inputs from any one or more of the components 210-290 (e.g., sensor information) of the power plant 200 as well as human operator commands. The sensor information is also represented by the dashed lines exiting the components. For simplicity, the actual couplings of the outputs from the components 210-290 to the controller 205 are not shown. The dashed lines exiting the controller 205 represent outputs provided to any one or more the same components 210-290 (e.g., control signals) as well as informational outputs to the human operator. The control information is also represented by the dashed lines entering the components. Again for ease of reading, the actual couplings of the outputs from the controller 205 to the components 210-290 are not shown.

The power plant 200 may include a GT system as the prime mover. In FIG. 2, the GT system comprises a compressor 210, a combustor 220, and a gas turbine 330. The compressor 210 may be configured to compress air and provide the compressed air—or more generically compressed oxidant—to the combustor 220. The combustor 220 may be configured receive the compressed air and fuel, and combust the fuel-air mixture to drive the gas turbine 330. The fuel may be gas and/or liquid. That is the combustor 220 is capable of both LF operation and GF operation.

The power plant 200 may further include a boiler feedwater pump (BFP) 280, a heat recovery steam generator (HRSG) 270 and a performance heater 250. The BFP 280 may fluidly communicate with the HRSG 270. Generally, two devices or elements may be said to be in fluid communication when there is a path for a fluid to flow from one device to the other. In this instance, it is seen that there is a path for a fluid (e.g., feedwater) to flow from the output of the BFP 280 to the input of the HRSG 270.

Note that two devices may be in fluid communication even if there are intervening elements. For example, it can be said that the BFP 280 fluidly communicates with the performance heater 250 even though the HRSG 270 may be in between. This is because there is a path for the feedwater to flow from the output of the BFP 280 to the input of the performance heater 250 via the HRSG 270.

The BFP 280 may be configured to provide feedwater at its output. As arranged in FIG. 2, the BFP 280 may be configured to provide the feedwater to the HRSG 270. For example, the BFP 280 may provide the feedwater to an economizer 272 of the HRSG 270. In one aspect, the BFP 280 may provide the feedwater from a bottoming cycle of the power plant 200. For example, the feedwater provided by the may be from a condenser (not illustrated) and pumped by a condenser extraction pump (CEP) 275.

The HRSG 270 may be configured to heat water received at its input and to output some or all heated water at its output. The output of the HSRG 270 may fluidly communicate with the input of the performance heater 250. As arranged, the HRSG 270 may be configured to heat the feedwater provided from the BFP 280. In one aspect, the exhaust from the gas turbine 230 may be the heat source used in the HRSG 270 to heat the feedwater. The heated feedwater from the HRSG 270 may be provided to the performance heater 250, and the performance heater 250 may be configured to heat the gas fuel using the heated feedwater from the HRSG 270 (e.g., from the economizer 272) during the GF operation. A heated feedwater valve 290 may be configured to regulate an amount of the heated feedwater exiting the HRSG 270.

The economizer 272 may be an intermediate pressure (IP) economizer or a high pressure (HP) economizer. Likewise, the BFP 280 may be either an IP BFP or a HP BFP. While not specifically illustrated, the heated feedwater used in the performance heater 250 may be from any combination one or both the IP and the HP economizers. In one instance, there may be two BFPs 280 and two heated feedwater valves 290 for the corresponding economizers 272. For the remainder of this description, one BFP 280 and one heated feedwater valve 290 will be assumed. But it should be recognized that the scope of the description readily encompasses multiple BFPs and/or multiple heated feedwater valves 290 corresponding to multiple economizers 272.

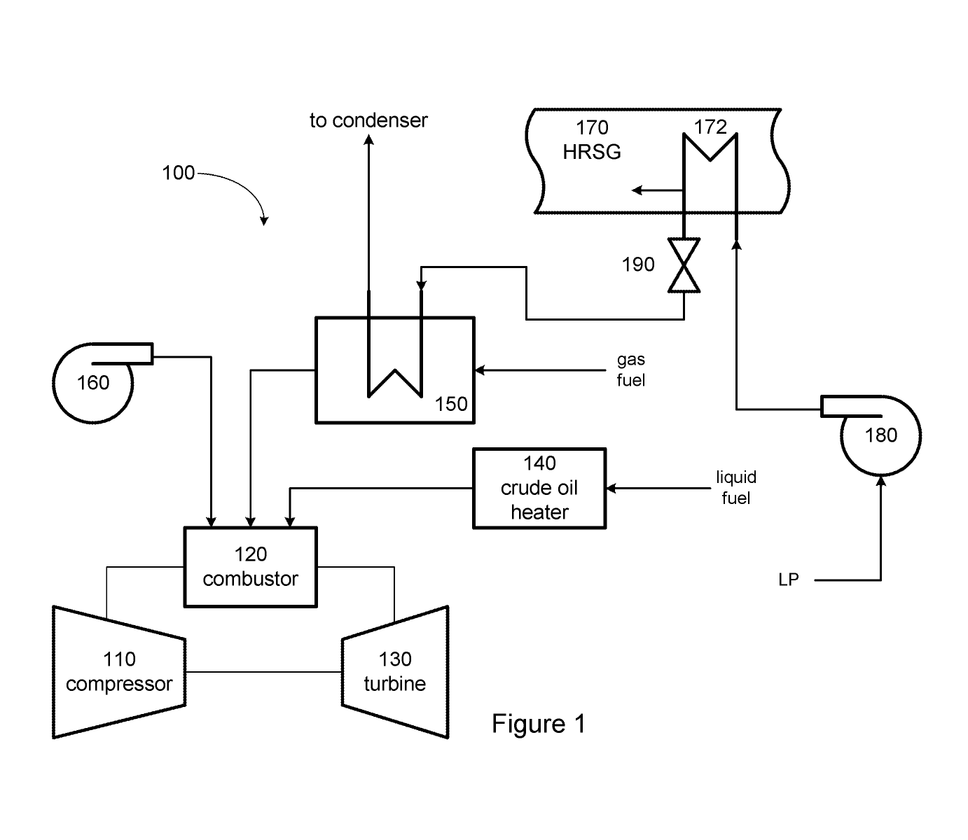

As previously mentioned, during the LF operation (e.g., during startup, part-load), the liquid fuel can be heated prior to combustion to increase efficiency. Also during the LF operation, water maybe injected into the combustor to reduce emissions. But in the conventional system (see FIG. 1 for example), a crude oil heater with an auxiliary heat source is used to heat the liquid fuel. This limits the limits the amount of combined cycle efficiency that can be gained. Also, water injection is accomplished through a separate water injection pump. This has the effect of making the foot print of equipments for the water injection and for the liquid fuel heating large and complex. This also limits the efficiency and increases costs.

However, the power plant 200 addresses some or all deficiencies of the conventional system. The power plant 200 enables the use of the feedwater provided by the BFP 280 for the liquid fuel heating. The power plant 200 enables the use of the feedwater from the BFP 280 also for water injection into the combustor 220.

In an embodiment, the power plant 200 may include a LF heater 235. The output of the HRSG 270 may be in fluid communication with the input of the LF heater 235. Since the HRSG 270 is in fluid communication with the BFP 280, it can also be said that the output of the BFP 280 fluidly communicates with the input of the LF heater 235 via the HRSG 270. The LF heater 235 may be configured to receive hot water at its input, heat liquid fuel prior to the liquid fuel being combusted in the combustor 220, and output the used hot water at its output. In this instance, due to the fluid communication, the hot water used by the LF heater 235 is the feedwater from the BFP 280 heated by the HRSG 270.

This is advantageous in that a separate auxiliary heat source is not required to heat the liquid fuel. Thus in one embodiment, there is no auxiliary heat source for liquid fuel heating. But in another embodiment, an auxiliary heat source may be used in combination with the heated feedwater from the HRSG 270.

In some instances, it may not be necessary and/or not desirable for the feedwater to flow into the LF heater 235. For example, if only gas fuel is being combusted in the combustor 220, i.e., no LF operation is taking place, then there would be no need for the liquid fuel heating. As another example, during a startup, the HRSG 270 may be unable to sufficiently heat the feedwater from the BFP 280 for liquid fuel heating. In this instance, even if LF operation is taking place, it may be more desirable to bypass the liquid fuel heating. Indeed, it may be more beneficial to bypass the HRSG 270 as well so as to allow the HRSG 270 to reach operating temperature quicker.

To enable such flexibilities, the power plant 200 may include a HRSG bypass valve 215, which may be configured to regulate an amount of water received at its input to pass through its output. As seen, the HRSG bypass valve 215 may be in a parallel arrangement with the HRSG 270. That is, the input and output of the HRSG bypass valve 215 may fluidly communicate respectively with the output of the BFP 280, and with the input of the water injector 255. With the parallel arrangement, the amount of the feedwater not passing through the HRSG bypass valve 215 can be directed to the HRSG 270. The amount of the feedwater passing through the HRSG bypass valve 215 may range between a minimum (as low as zero) and a maximum (as much as all). This implies that the amount of the feedwater directed to the HRSG 270 can also range between some minimum and maximum.

The power plant 200 may include a LF heater bypass valve 225, which may also be configured to regulate an amount of water received at its input to pass through its output. The LF heater bypass valve 225 may be in a parallel arrangement with the LF heater 235. That is, the input and output of the LF heater bypass valve 225 may fluidly communicate respectively with the output of the HSRG 270, and with the input of the water injector 255. The input of the LF heater bypass valve 225 may fluidly communicate output of the HRSG bypass valve 215. With the parallel arrangement, the amount of the feedwater not passing through the LF heater bypass valve 225 can be directed to the LF heater 235. The amount of the feedwater passing through the LF heater bypass valve 225 may range between a minimum and maximum, which implies that the amount of the feedwater directed to the LF heater 235 can also range between some minimum and maximum.

In one aspect, when the controller 205 may determine whether the liquid fuel is to be heated. For example, during the LF operation, sensor information may indicate that the temperature of the liquid fuel is lower than a desired temperature. When it is determined that the liquid fuel should be heated, the controller 205 may control the HRSG bypass valve 215 such that at least some, i.e., a non-zero amount, of the feedwater from the BFP 280 is directed to the HRSG 270. In this way, heated feedwater should be available. The controller 205 may also control the LF heater bypass valve 225 such that a non-zero amount of the heated feedwater is directed to the LF heater 235.

Note that by controlling any one or more of the BFP 280, the HRSG 270, the HRSG bypass valve 215, the LF heater bypass valve 225, and the LF heater 235, the controller 205 can regulate the heat exchange occurring the LF heater 235 during the LF operation. For example, the controller 205 may control the temperature and/or the flow rate of the feedwater entering the LF heater 235.

The power plant 200 may further include a water injector 255, which may be configured to receive water at its input and inject the received water into the combustor 220. The input of the water injector 255 may fluidly communicate with the output of the BFP. In this instance, due to the fluid communications, the water injected into the combustor 220 by the water injector 255 is the feedwater from the BFP 280. That is, the same feedwater used for the liquid fuel heating may also be used for water injection. This is further evidenced by noting that the output of the LF heater 235 can be in fluid communication with the input of the water injector 255 as well. Note that the input of the water injector 255 may also fluidly communicate with the output of the HRSG 270.

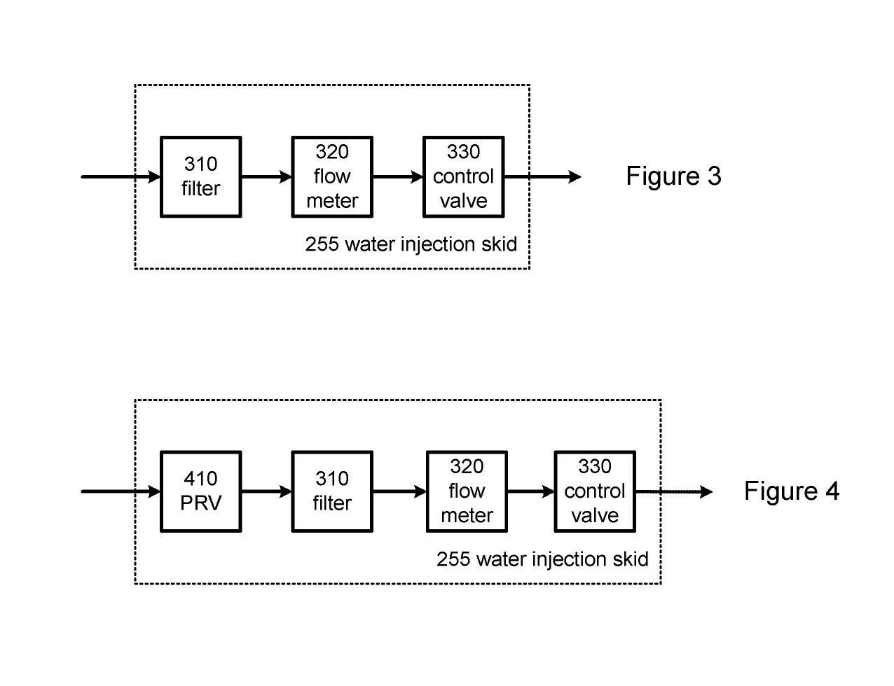

FIG. 3 illustrates a water injector according to an embodiment of the present invention. The water injector 255 may comprise a filter 310, a flow meter 320, and a control valve 330. The filter 310 may be configured to filtrate the received water—any combination of the heated and unheated feedwaters—prior to injection into the combustor 220. The flow meter 320 may be configured to measure flow rate of the water injected into the combustor 220, and the control valve 330 may be configured to control the water injected into the combustor 220. For example, the flow rate information may be conveyed to the controller 205 as a sensor signal, and the controller 205 may provide a control signal to operate the control valve 330.

FIG. 4 illustrates a water injector according to another embodiment of the present invention. In this figure, the water injector 255 may additionally include a pressure regulating valve (PRV) 410 configured to regulate the pressure of the water entering the water injector 255.

Referring back to FIG. 2, the power plant 200 may include a multi-way valve 245, e.g., a three-way valve 245. The three-way valve 245 valve may be configured to receive water at its input and direct the received water to one or both of its first and second outputs. The input of the three-way valve 245 may fluidly communicate with the output of the LF heater bypass valve 225 and with the output of the LF heater bypass valve 225. In effect, the input of the three-way valve 245 can fluidly communicate with the output of the BFP 280 and with the output of the HRSG 270. The first and second outputs of the three-way valve 245 may fluidly communicate respectively with the input of the water injector 255, and with a condenser. The amount of the feedwater directed to the first and second outputs may be fully controllable.

Note that it is not necessary for the water injection to take place all the time. In one aspect, the controller 205 may determine whether the water injection should take place. For example, sensor information may indicate that the GT system is under a part load (e.g., 30% load or more). In which case, water injection may be useful for NOx abatement. When it is determined that the water injection should take place, the controller 205 may control the three-way valve 245 such that a non-zero amount of the feedwater is directed to the first output, i.e., towards the water injector 255. On the other hand, when it is determined that the water injection should not take place, the controller 205 may control the three-way valve 245 to direct all received feedwater to the second output.

Whenever water injection does take place, the amount of feedwater used for the water injection should be made up. In FIG. 2, makeup water may be supplied to make up for the feedwater lost through water injection.

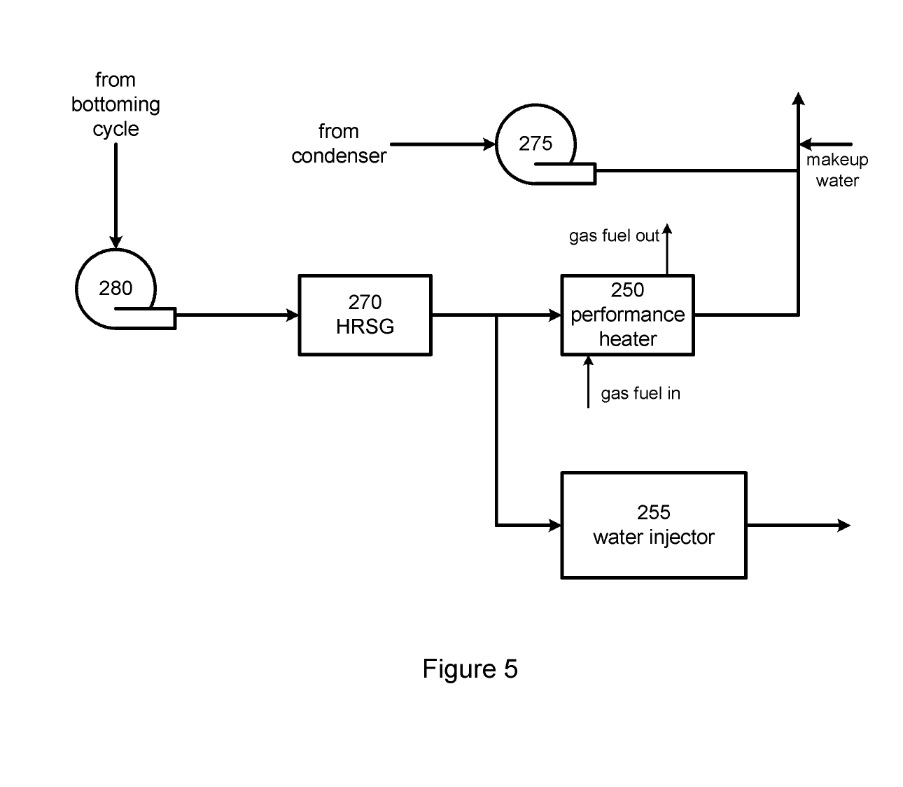

Any combination of the heated and/or unheated feedwater may be injected into the combustor 220. Unheated water refers to the portion of the feedwater that is not heated by the HRSG 270. This may correspond to the amount of feedwater that passes through the HRSG bypass valve 215. FIG. 5 is a schematic of a heated feedwater injection mode according to an embodiment of the present invention. For simplicity, not all of the components of the power plant 200 are reproduced. As seen, the heated feedwater from the HRSG 270 may be provided to the water injector 255 (e.g., in a form of a water injection skid) for injection into the combustor 220. The controller 205 may control the HRSG bypass valve 215 such that all feedwater from the BFP 280 is directed to the HRSG 270.

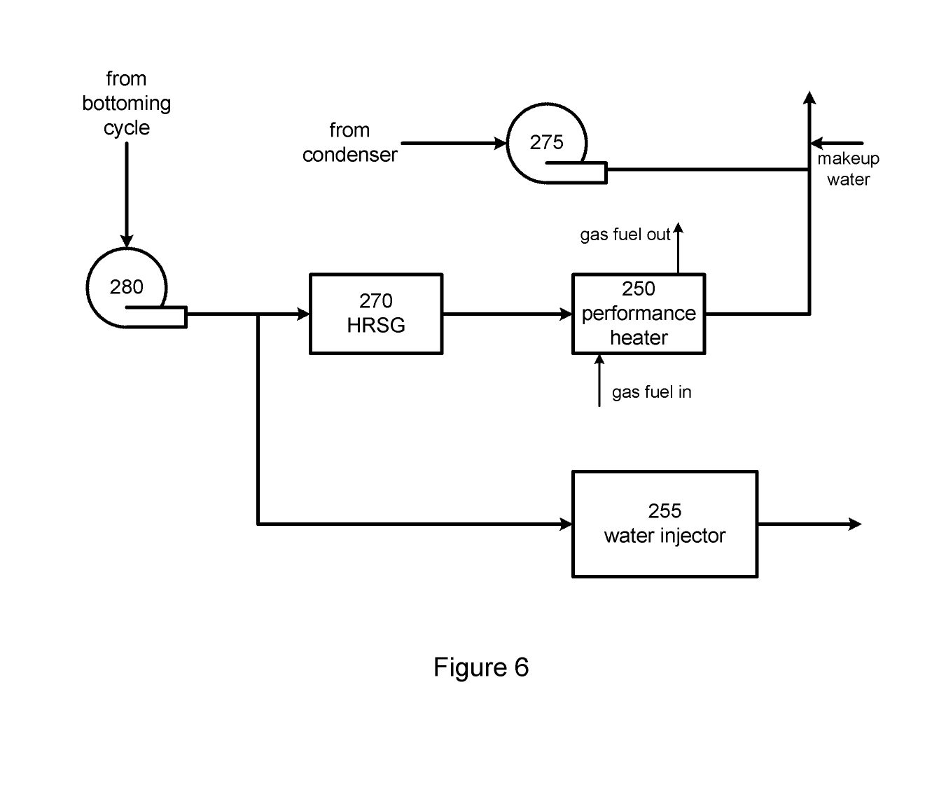

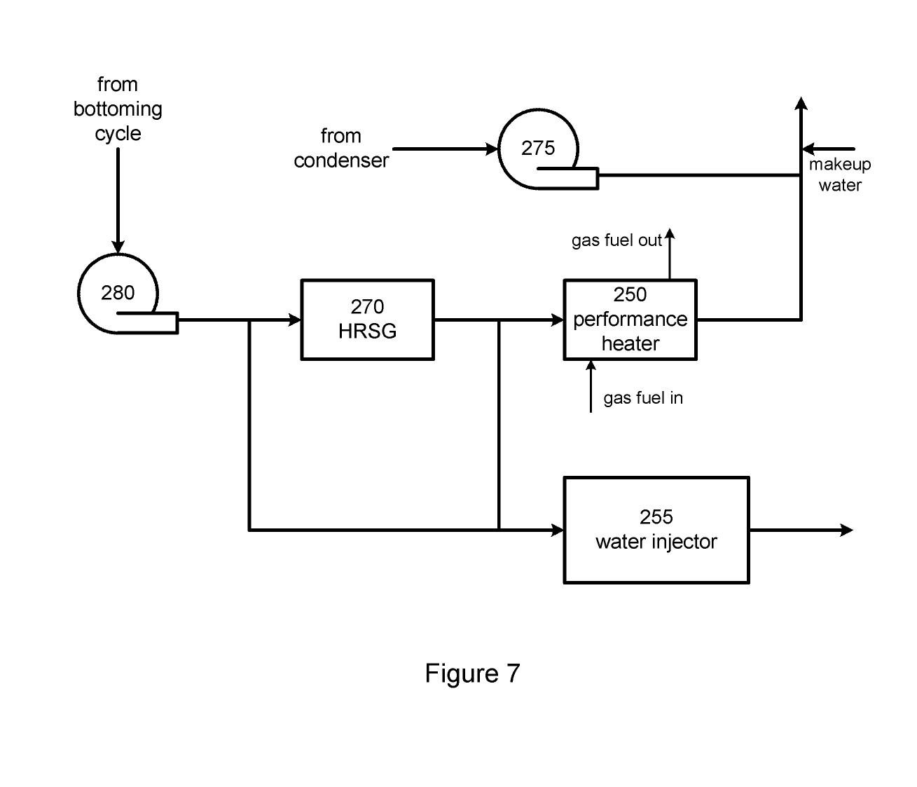

FIG. 6 illustrates a schematic of an unheated feedwater injection according to an embodiment of the present invention. As seen, the feedwater from the BFP 280 may be provided to the water injector 255 without being heated by the HRSG 270. The controller 205 may control the HRSG bypass valve 215 such that all feedwater from the BFP 280 passes through the HRSG bypass valve 215. Of course, as illustrated in FIG. 7, a combination of heated and unheated feedwater may be injected as well. The controller 205 may control the HRSG bypass valve 215 such that some, but not all, feedwater from the BFP 280 passes through the HRSG bypass valve 215.

While not illustrated in FIGS. 5-7, the controller 205 may also operate LF heater bypass valve 225 such that none, some, or all feedwater (heated and/or unheated) passes through the LF heater bypass valve 235. This implies that at least some of the feedwater used for liquid fuel heating may also be used for water injection.

Of course, it is also possible for the all of the feedwater injected is unheated, e.g., when the HRSG bypass valve 215 and the LF heater bypass valve 225 are both in full bypass operation. This may occur, for example, during startup.

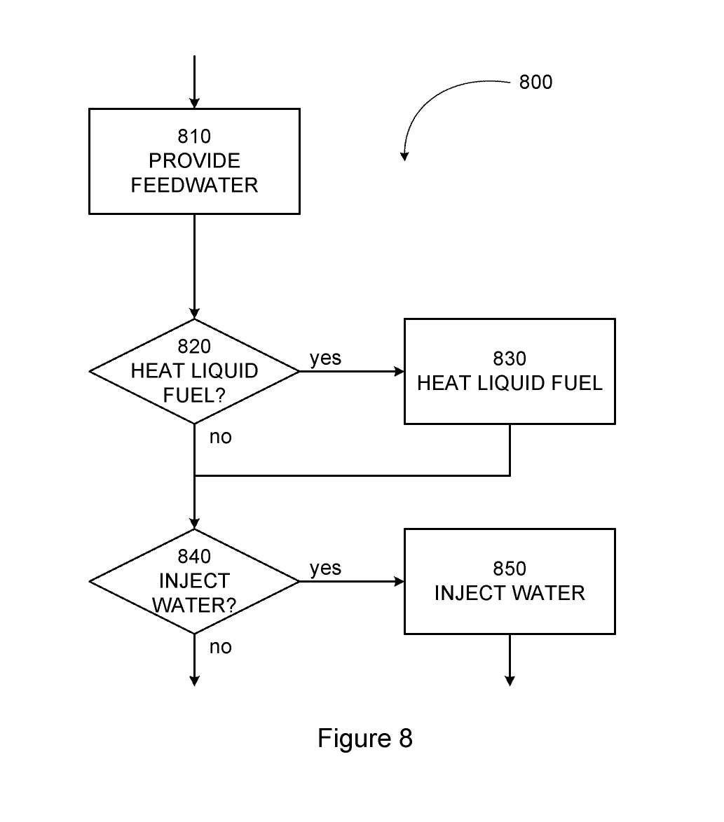

In FIG. 8, a flow chart of an example method to operate a power plant is illustrated. The example method 800 may be implemented in the controller 205 to control the operations of the power plant 200. As seen, in step 810, the controller 205 may control the BFP 280 to provide the feedwater to the fluid path towards the HRST 270 and the LF heater 235.

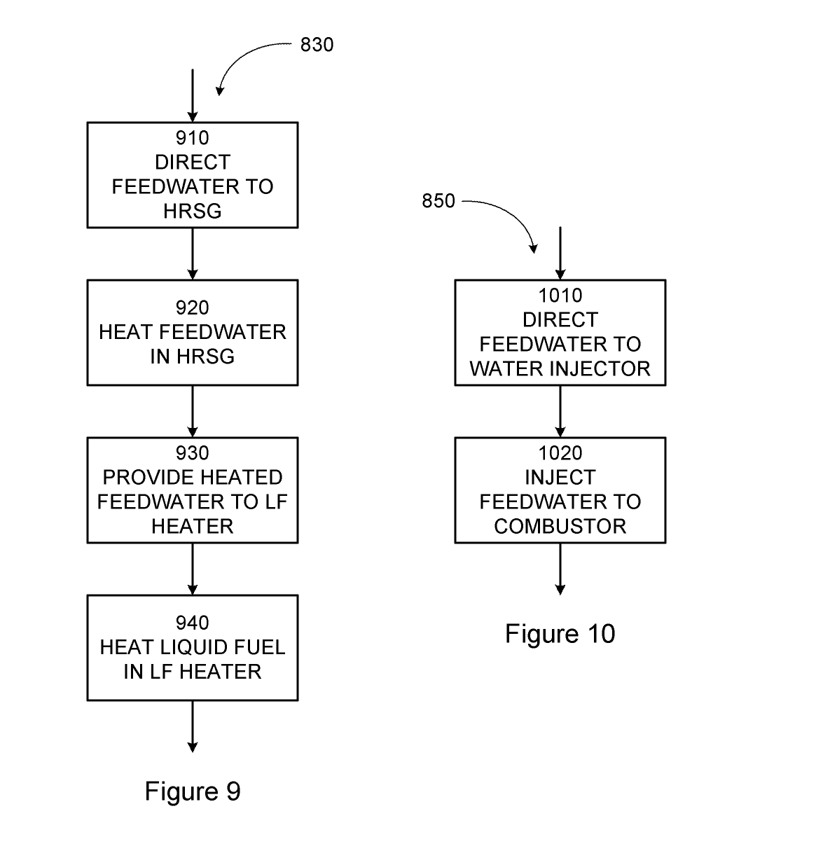

In step 820, the controller 205 may determine whether or the liquid fuel supplied to the combustor 220 should or should not be heated. When it is determined that the liquid fuel should be heated, the controller 205 may proceed to heating the liquid fuel in step 830. FIG. 9 illustrates a flow chart of an example process to perform the liquid fuel heating step. As seen, the feedwater from the BFP 280 may be directed to the HRSG 270 in step 910. For example, the controller 205 may operate the HRSG bypass valve 215 such that a non-zero amount of the feedwater from the BFP 280 is directed to the HRSG 270. In step 920, the directed feedwater may be heated in the HRSG 270. In step 930, the heated feedwater may be provided to the LF heater 235. For example, the controller 205 may operate the LF heater bypass valve 225 such that a non-zero amount of the heated feedwater is directed to the LF heater 235. In step 940, the liquid fuel may be heated in the LF heater 235 using the heated feedwater.

Referring back to FIG. 8, the controller 205 may determine whether water injection into the combustor 220 should or should not take place in step 840. When it is determined that the water injection should take place, the method may proceed to injecting the feedwater in step 850. FIG. 10 illustrates a flow chart of an example process to perform the water injection step. As seen, the feedwater from the BFP 280 may be directed to the water injector 255 in step 1010. For example, the controller 205 may operate the three-way valve 245 such that a non-zero amount of the feedwater is directed to the water injector 255. In step 1020, the directed feedwater may be injected into the combustor 220 by the water injector 255.

In one or more of the inventive aspects, the feedwater provided from a boiler feedwater pump can be used for liquid fuel heating. This has the advantage in that no auxiliary heat source is required. The feedwater from the boiler feedwater pump can also be used for water injection into the combustor. This has the advantage in that overall liquid fuel heating and water injection may be simplified.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A liquid fuel heating and water injection system of a power plant, the system comprising:
a boiler feedwater pump (BFP) configured to provide feedwater at its output;
a heat recovery steam generator (HRSG) configured to heat water received at its input and to output some or all heated water at its output;
a liquid fuel (LF) heater configured to receive hot water at its input, heat liquid fuel prior to the liquid fuel being combusted in a combustor, and output the used hot water at its output; and
a water injector configured to receive water at its input and inject the received water into the combustor,
wherein the output of the BFP fluidly communicates with the input of the HRSG and with the input of the water injector,
wherein the output of the HRSG fluidly communicates with the input of the LF heater and with the input of the water injector, and
wherein the output of the LF heater fluidly communicates with the input of the water injector.

2. The system of claim 1, wherein the output of the BFP also fluidly communicates the input of the LF heater.

3. The system of claim 1, further comprising:
a HRSG bypass valve configured to regulate an amount of water received at its input to pass through its output,
wherein the input of the HRSG bypass valve fluidly communicates with the output of the BFP,
wherein the output of the HRSG bypass valve fluidly communicates with the input of the water injector, and
wherein the HRSG bypass valve is in a parallel arrangement with the HRSG such that an amount of feedwater not passing through the HRSG bypass valve is directed to the HRSG.

4. The system of claim 3, wherein the output of the HRSG bypass valve also fluidly communicates with the input of the LF heater.

5. The system of claim 3, further comprising:
a LF heater bypass valve configured to regulate an amount of water received at its input to pass through its output,
wherein the input of the LF heater bypass valve fluidly communicates with the output of the HRSG and with the output of the HRSG bypass valve,
wherein the output of the LF heater bypass valve fluidly communicates with the input of the water injector, and
wherein the LF heater bypass valve is in a parallel arrangement with the LF heater such that an amount of feedwater not passing through the LF heater bypass valve is directed to the LF heater.

6. The system of claim 5,
wherein the power plant operates in a LF operation, the LF operation being when the liquid fuel is combusted in the combustor, and
wherein the HRSG bypass valve and the LF heater bypass valve are configured such that during at least a part of the LF operation,
the HRSG bypass valve directs a non-zero amount of the feedwater from the BFP to the HRSG, and
the LF heater bypass valve directs a non-zero amount of the heated feedwater from the HRSG to the LF heater.

7. The system of claim 5, further comprising:
a three-way valve configured to receive water at its input and direct the received water to one or both of its first and second outputs,
wherein the input of the three-way valve fluidly communicates with the output of the LF heater bypass valve and with the output of the LF heater bypass valve,
wherein the first output of the three-way valve fluidly communicates with the input of the water injector, and
wherein the second output of the three-way valve fluidly communicates with a condenser.

8. The system of claim 7, further comprising wherein the three-way valve is configured such that
when the water injection to the combustor is to take place, a non-zero amount of the received feedwater is directed to its first output, and
when the water injection to the combustor should not take place, all of the received feedwater is directed to its second output.

9. The system of claim 1, wherein the BFP is configured to supply the feedwater from a bottoming cycle of the power plant.

10. The system of claim 1, wherein the BFP is a low pressure (LP) BFP or an intermediate pressure (IP) BFP.

11. The system of claim 1, wherein the water injector comprises:
a filter configured to filtrate the feedwater prior to injection into the combustor;
a flow meter configured to measure flow rate of the feedwater injected into the combustor; and
a control valve configured to control the feedwater injected into the combustor.

12. The system of claim 11, wherein the water injector further comprises a pressure regulating valve (PRV) configured to regulate pressure of the feedwater entering the water injector.

13. A power plant, comprising:
a compressor, a combustor, and a gas turbine (GT), the combustor configured to combust a fuel-air mixture to drive the gas turbine, the fuel-air mixture comprising a mixture of compressed air from the compressor and fuel, the fuel being gaseous and/or liquid;
a boiler feedwater pump (BFP) configured to provide feedwater at its output;
a heat recovery steam generator (HRSG) whose input fluidly communicates with the output of the BFP, the HSRG configured to heat the feedwater received at its input and output at least some of the heated feedwater its output;
a liquid fuel (LF) heater whose input fluidly communicates with the output of the HSRG, the LF heater configured to heat the liquid fuel prior to the liquid fuel being combusted in the combustor using the received heated feedwater at its input and output the used heated feedwater at its output;
a water injector whose input fluidly communicates with the output of the BFP and the output of the HRSG, the water injector configured to receive the feedwater at its input and inject the received feedwater into the combustor, and
a controller configured to control operations of the power plant.

14. The power plant of claim 13, wherein the controller is configured to:
determine whether or not the liquid fuel is to be heated; and
when it is determined that the liquid fuel is to be heated, control the operations of the power plant so as to
direct a non-zero amount of the feedwater from the BFP to the HRSG, and
direct a non-zero amount of the heated feedwater from the HRSG to the LF heater.

15. The power plant of claim 14, further comprising:
a HRSG bypass valve configured to regulate an amount of water received at its input to pass through its output, the input of the HRSG bypass valve fluidly communicating with the output of the BFP, the output of the HRSG bypass valve fluidly communicating with the input of the water injector, and the HRSG bypass valve being in a parallel arrangement with the HRSG such that an amount of the feedwater not passing through the HRSG bypass valve is directed to the HRSG,
wherein when it is determined that the liquid fuel is to be heated, the controller directs the non-zero amount of the feedwater from the BFP to the HRSG by controlling the HRSG bypass valve.

16. The power plant of claim 14, further comprising:
a LF heater bypass valve configured to regulate an amount of water received at its input to pass through its output, the input of the LF heater bypass valve fluidly communicating with the output of the HRSG and with the output of the HRSG bypass valve, the output of the LF heater bypass valve fluidly communicating with the input of the water injector, and the LF heater bypass valve being in a parallel arrangement with the LF heater such that an amount of the feedwater not passing through the LF heater bypass valve is directed to the LF heater,
wherein when it is determined that the liquid fuel is to be heated, the controller directs the non-zero amount of the feedwater from the HRSG to the LF heater by controlling the HRSG bypass valve.

17. The power plant of claim 13, wherein the controller is configured to:
determine whether water injection into the combustor should or should not take place,
when it is determined that the water injection should take place, control the operations of the power plant so as to direct a non-zero amount of the feedwater from the BFP and/or the HRSG to the water injector, and
when it is determined that the water injection should not take place, control the operations of the power plant so as to direct all of the feedwater from the BFP and/or the HRSG towards a condenser.

18. The power plant of claim 17, further comprising:
a three-way valve configured to receive water at its input and direct the received water to one or both of its first and second outputs, the input of the three-way valve fluidly communicating with the output of the BFP and the output of the HRSG, the first output of the three-way valve fluidly communicating with the input of the water injector, and the second output of the three-way valve fluidly communicating with the condenser,
wherein when it is determined that the water injection should take place, the controller controls the three-way valve so as to direct the non-zero amount of the feedwater from the BFP and/or the HRSG to its first output, and
wherein when it is determined that the water injection should not take place, the controller controls the three-way valve so as to direct all of the feedwater from the BFP and/or the HRSG to its second output.

19. A method of operating a power plant, the power plant comprising a boiler feedwater pump (BFP), a heat recovery steam generator (HRSG) downstream of the BFP in a fluid path, a liquid fuel (LF) heater downstream of the HRSG in the fluid path, and a water injector downstream of the LF heater in the fluid path, the method comprising:
providing feedwater to the fluid path towards the HSRG and the LF heater using the BFP;
determining whether liquid fuel supplied to a combustor should or should not be heated;
heating the liquid fuel using the feedwater from the BFP when it is determined that the liquid fuel should be heated;
determining whether water injection into the combustor should or should not take place; and
injecting the feedwater from the BFP into the combustor when it is determined that the water injection should take place,
wherein the step of heating the liquid fuel comprises:
directing the feedwater from BFP to the HRSG;
heating directed feedwater in the HSRG;
providing the heated feedwater to the LF heater; and
heating the liquid fuel in the LF heater using the heated feedwater from the HSRG, and
wherein the step of injecting the feedwater into the combustor comprises:
directing the feedwater from the BFP to the water injector; and
injecting the feedwater into the combustor using the water injector.

20. The method of claim 19,
wherein the power plant further comprises an HRSG bypass valve downstream of the BFP and in parallel arrangement with the HRSG, a LF heater bypass valve downstream of the HRSG and the HRSG bypass valve in the fluid path and in parallel arrangement with the LF heater, and a three-way valve downstream of the a LF heater bypass valve and upstream of the water injector 255) in the fluid path,
wherein the step of directing the feedwater from BFP to the HRSG comprises operating the HRSG bypass valve such that a non-zero amount of the feedwater is directed to the HRSG,
wherein the step of providing the heated feedwater to the LF heater comprises and operating the LF heater bypass valve such that a non-zero amount of the heated feedwater is directed to the LF heater, and
wherein the step of directing the feedwater from the BFP to the water injector comprises operating the three-way valve such that a non-zero amount of the feedwater is directed to the water injector.
